(19) United States
(12) Patent Application Publication
(10) Pub. No.: US 2011/0166280 A1
(43) Pub. Date: Jul. 7, 2011

(54) Sealant Composition

(76) Inventors: Delphine Davio, Le Roeulx (BE); Andreas Stamer, Obaix (BE)

(21) Appl. No.: 12/809,403

(22) PCT Filed: Dec. 17, 2008
(86) PCT No.: PCT/EP08/10756

§ 371 Date: Mar. 22, 2011

(30) Foreign Application Priority Data
Dec. 21, 2007 (GB) 0724943.6

(51) Int. Cl. C08K 3/34; C09D 183/04

(52) U.S. Cl. 524/447

(57) ABSTRACT

A moisture curable sealant composition comprising an organopolysiloxane (A) containing reactive hydroxyl or hydrolysable groups bonded to silicon, a crosslinking agent (B) containing hydrolysable groups reactive with the reactive groups of (A) in the presence of moisture, the hydrolysable groups of (B) releasing an acid in the presence of moisture, a metal-containing catalyst for the reaction of the reactive groups of (A) with the hydrolysable groups of (B), and a filler, characterized in that the filler comprises calcined kaolin and is free of any other reinforcing filler and methanol and in the fact that the composition upon curing has a elongation at break of more than 250% and is non sagging.

This invention relates to moisture curable sealant compositions comprising an organopolysiloxane (A) containing reactive hydroxyl or hydrolysable groups bonded to silicon and a crosslinking agent (B) containing hydrolysable groups reactive with the reactive groups of (A) in which the hydrolysable groups of the crosslinking agent (B) release an acid in the presence of moisture. Such silicone sealant compositions also contain a metal-containing catalyst for the reaction of the reactive groups of (A) with the hydrolysable groups of (B), and a filler.

The sealants described above are generally used to seal joints for example construction joints and as such are required to be able to seal a variety of construction joints of varying geometry etc. and preferred sealants are those able to seal joints in as many situations as possible. Preferred sealants need several physical properties in order to maintain a seal subsequent to curing in place. For example construction joints and therefore the sealants sealing them are generally subjected to movement (e.g. caused by thermal expansion or shrinkage of the substrates forming the joints). In order to cope with this repeated movement a sealant needs to have a degree of elasticity. The elasticity of a sealant may be determined from several physical properties generally measured e.g. elongation at break (maximum elongation), modulus at 100% elongation and tensile strength. While unfilled silicone elastomers can show very high elongations at break of more than 500%, their modulus, tensile strength, hardness and tear resistance are too low for the cured sealant to function successfully in sealing construction applications. In order to improve the overall elastic characteristics of such sealants to render them functional for sealing construction joints, reinforcing fillers need to be added to the formulation. The choice of filler for a sealant composition is often therefore a compromise of many requirements.

The preferred filler for many silicone sealants is fumed silica, which acts as a reinforcing filler achieving acceptable rheology and good mechanical properties in the cured sealant. Silica is however a relatively expensive filler. This cost perspective has lead the industry to seek alternative sufficiently reinforcing fillers which provide the sealant with appropriate elastic characteristics. Many silicone sealants can be formulated with calcium carbonates in place of silica as a lower cost filler, but this is not possible with cure systems which release acid, because the calcium carbonate reacts with the acid released. At present no commercially viable lower cost filler (i.e. low cost alternative to silica) has been identified for this type of sealant.

DE-A-3439745 describes a sealant prepared from silicone with acetoxysilanes as crosslinking agents and dibutyltin diacetate as catalyst, and a silicate filler which has been surface treated with an organofunctional silane. The filler can for example be kaolinite, wollastonite, talc or barytes. The surface treatment of fillers is identified as an essential feature and can lead to significant increased expense and as such negate the suitability of such fillers as cheap alternatives to silica.

U.S. Pat. No. 4,929,664 describes a crosslinkable hydroxyl-terminated polydimethylsiloxane compounded with an oxime crosslinker, a tin catalyst and a platy talc reinforcing agent. The platy talc. Kaolin is used as a filler in a comparative example herein but it was taught that the kaolin filled composition was unsuitable because of poor dispersion of the filler in the composition compared to the talc.

US-A-20070179242 describes a moisture curable sealant composition based on a silylated resin, and mentions kaolinite as a possible filler. Similarly US-A-2007-173596 describes a moisture curable composition based on a diorganopolysiloxane and an organic nanoclay, and mentions kaolinite as a possible filler.

U.S. Pat. No. 6,342,575 describes an RTV curable organopolysiloxane composition incorporating hydroxyl groups bonded to silicon, a methyltriacetoxysilane curing agent and methanol. It may also contain a filler, one of those listed being calcined clay. Condensation catalysts are also preferred. Methanol is used to facilitate the use of the methyltriacetoxysilane which has a melting point of about 30° C. and which would otherwise need to be heated prior to use (when used alone) and could, depending on temperature, resolidify.

While flowable sealants are often used in horizontal applications, such as highway joints, many construction applications require the sealant to have sufficient sag control in the uncured state in order to enable uncured sealant compositions to be applied to/in overhead crevices and wall crevices (typically referred to as vertical joints) and remain there as applied or subsequent to working, without flowing out of the crevice, until it cures to form a silicone elastomeric seal. Hence sag-control is intended to mean that the composition in the uncured state is extrudable and flowable but when only subjected to the forces of gravity, the applied uncured sealant composition will stay where applied without flowing before it cures to an elastomeric body. Hence it can be seen that sag-control is an important property for silicone sealants used in the construction industry for sealing, in particular vertical joints.

While generally the “sag” of sealants may be reduced by the addition of large amounts of fillers (reinforcing or non-reinforcing) it will be appreciated that as mentioned above the sealants still need to be extrudable in the uncured state in order to be applied on to e.g. a construction joint. Furthermore the amounts of filler required to provide non sag properties in a silicone sealant formulation can lead to poor mechanical properties in particular low elongation.

EP 0933398 describes a process for preparing a one-package RTV organopolysiloxane composition organopolysiloxane (A) containing reactive hydroxyl or hydrolysable groups bonded to silicon, a crosslinking agent (B) containing hydrolysable groups, and a filler (C). A wide variety of fillers are listed one of which is calcined clay, although the examples use silica or calcium carbonate as the filler. It is suggested that despite the lack of sag control agents the composition shows good sag control and improved slump properties.

Surprisingly it was found that calcined kaolin can provide the desired non sag properties together with good mechanical properties.

We have found according to the invention that using calcined kaolin as the reinforcing filler can provide the desired non sag properties together with good mechanical properties upon curing such as high tensile strength, high Shore A hardness and high tear resistance and in particular high elongation at break in a moisture curable sealant composition comprising an organopolysiloxane containing reactive hydroxyl or hydrolysable groups bonded to silicon, a crosslinking agent containing hydrolysable groups reactive with the reactive groups of the organopolysiloxane in the presence of moisture, and a metal-containing catalyst, even if the hydrolysable groups of the crosslinking agent release an acid in the presence of moisture.

In accordance with the present invention there is provided a moisture curable sealant composition comprising an organopolysiloxane (A) containing reactive hydroxyl or hydrolysable groups bonded to silicon, a crosslinking agent (B) containing hydrolysable groups reactive with the reactive groups of (A) in the presence of moisture, the hydrolysable groups of (B) releasing an acid in the presence of moisture, a metal-containing catalyst for the reaction of the reactive groups of (A) with the hydrolysable groups of (B), and a filler, characterized in that the filler comprises calcined kaolin and is free of any other reinforcing filler and methanol and in the fact that the composition upon curing has a elongation at break of more than 250% and is non sagging.

For the sake of this invention a non-sagging sealant composition is one that has a value of less than 5 mm flow after 15 minutes as measured by ASTM D2202. A reinforcing filler is a filler added to improve physical properties as compared to a non-reinforcing filler which is typically introduced into the composition to reduce the cost thereof.

The organopolysiloxane (A) generally contains at least two hydroxyl or hydrolysable groups, preferably terminal hydroxyl or hydrolysable groups. The polymer can for example have the general formula

X¹-A′-X² (1)

where X¹ and X² are independently selected from silicon containing groups which contain hydroxyl or hydrolysable substituents and A′ represents a polymer chain. Examples of X¹ or X² groups incorporating hydroxyl and/or hydrolysable substituents include groups terminating as described below:
—Si(OH)₃, —(R^{a})Si(OH)₂, —(R^{a})₂SiOH, —R^{a}Si(OR^{b})₂, —Si(OR^{b})₃, —R^{a}₂SiOR^{b} or —R^{a}₂Si—R^{c}—SiR^{d}ₚ(OR)₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl or alkoxy group in which the alkyl groups suitably have up to 6 carbon atoms; R^{c} is a divalent hydrocarbon group which may be interrupted by one or more siloxane spacers having up to six silicon atoms; and p has the value 0, 1 or 2.

Hydroxy-terminated organopolysiloxanes, particularly polydiorganosiloxanes, are widely used in sealants and are suitable for use in the present invention. The organopolysiloxane (A) preferably includes siloxane units of formula (2)

-(R⁵ₛSiO_{(4-s/2})— (2)

in which each R⁵ is independently an organic group such as a hydrocarbon group having from 1 to 18 carbon atoms, a substituted hydrocarbon group having from 1 to 18 carbon atoms or a hydrocarbonoxy group having up to 18 carbon atoms and s has, on average, a value of from 1 to 3, preferably 1.8 to 2.2. In a substituted hydrocarbon group, one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

Preferably each R⁵ is a hydrocarbyl group having from 1 to 10 carbon atoms optionally substituted with one or more halogen group such as chlorine or fluorine and s is 0, 1 or 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

The polymer (A), particularly if it is an polydiorganosiloxane, may have a viscosity of up to 20,000,000 mPa·s, at 25° C. and may contain up to or even more than 200,000 units of formula (2). Polydiorganosiloxanes comprising units of the formula (2) may be homopolymers or copolymers which may be in either block form or in a random continuation. Mixtures of different polydiorganosiloxanes are also suitable. In the case of polydiorganosiloxane co-polymers the polymeric chain may comprise a combination of blocks made from chains of units depicted in FIG. (2) above where the two R⁵ groups are:

both alkyl groups (preferably both methyl or ethyl), or

alkyl and phenyl groups, or

alkyl and fluoropropyl, or

alkyl and vinyl or

alkyl and hydrogen groups.

Typically at least one block will comprise siloxane units in which both R⁵ groups are alkyl groups.

The crosslinker (B) preferably contains at least two and preferably at least three groups which are reactive with the silicon-bonded hydroxyl or hydrolysable groups of polymer (A) and which release an acid in the presence of moisture. The reactive groups of crosslinker (B) are themselves preferably silicon bonded hydrolysable groups. The hydrolysable groups in the crosslinker can for example be acyloxy groups such as acetoxy, octanoyloxy, propionoxy or benzoyloxy groups The cross-linker can for example be one or more silanes and/or one or more short chain organopolysiloxane, for example a polydiorganosiloxane having from 2 to about 100 siloxane units. The molecular structure of such an organopolysiloxane can be straight chained, branched, or cyclic. The crosslinker (B) can alternatively be an organic polymer substituted by silicon-bonded hydrolysable groups which release an acid in the presence of moisture.

When the crosslinking agent (B) is a silane having three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably the fourth silicon-bonded organic group is methyl or ethyl.

Examples of crosslinking agents (B) include acyloxysilanes, particularly acetoxysilanes such as methyltriacetoxysilane, vinyltriacetoxysilane, ethyltriacetoxysilane, di-butoxy diacetoxysilane and/or dimethyltetraacetoxydisiloxane, and also phenyl-tripropionoxysilane. Further examples are short chain organopolysiloxanes containing acyloxy groups such as triacetoxysilyl groups or methyldiacetoxysilyl groups, or an acyloxy-functional organic polymers such as a polyether, for example polypropylene oxide tipped with triacetoxysilyl groups or methyldiacetoxysilyl groups. Preferably when methyltriacetoxysilane, is used as the primary cross-linker it is mixed, in appropriate proportions, with one or more other triacetoxysilanes such as ethyltriacetoxysilane, propyltriacetoxysilane and/or vinyltriacetoxysilane or the like in order to avoid solidification. Alternatively the dimer and/or trimer of methyltriacetoxysilane may also used together with methyltriacetoxysilane. As a further alternative methoxysilanes can be introduced in minor proportions to prevent solidification of methyltriacetoxysilane.

The amount of crosslinking agent (B) present in the composition will depend upon the particular nature of the crosslinking agent, particularly its molecular weight. The compositions suitably contain crosslinker (B) in at least a stoichiometric amount as compared to the polymer (A). Based on 100 parts by weight of polymer (A), compositions may contain, for example, from 1 to 30 parts by weight of crosslinker (B), generally from 2 to 20 parts by weight. For example, acetoxysilane may typically be present in amounts of from 3 to 10 parts by weight per 100 parts by weight of polymer (A).

The metal-containing catalyst acts as a condensation catalyst for the reaction of the reactive groups of polysiloxane (A) with the hydrolysable groups of crosslinker (B), increasing the speed at which the composition cures. The catalyst chosen for inclusion in a particular silicone sealant composition depends upon the speed of cure required. Suitable catalysts include compounds of tin, lead, antimony, iron, cadmium, barium, manganese, zinc, chromium, cobalt, nickel, aluminium, gallium, titanium, germanium or zirconium. Examples include organic tin metal catalysts such as triethyltin tartrate, tin octoate, tin oleate, tin naphthate, butyltintri-2-ethylhexoate, tinbutyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate, dibutyltin dibenzoate, stannous octoate, dimethyltin dineodeconoate, dibutyltin dioctoate of which dibutyltin dilaurate, dibutyltin diacetate are particularly preferred. Other examples include 2-ethylhexoates of iron, cobalt, manganese, lead and zinc.

The amount of metal-containing catalyst used is typically in the range from 0.005 to 3% by weight of the total composition. Preferably the catalyst is present in an amount of from 0.01 to 1 weight % of the composition.

The calcined kaolin is kaolin which has been heated to remove its water of crystallization. Calcined kaolin is formed by heating kaolin to above 700° C., typically to 1000° C. Such heating generally produces a very white, high surface area mineral with an inert surface. Calcination can alternatively be carried out by the process called “flash calcination” leading to closed pores in the filler which are not accessible for a sealant or coating binder. The calcined kaolin used in this invention the latter can be formed by either of these processes. We have found that non-calcined kaolin and metakaolin (kaolin which is partially calcined by heat treating up to 600° C.) do not form a shelf stable sealant composition when used with acetoxysilane crosslinkers. Examples of preferred commercially available calcined kaolins include, products sold by, for example Imerys under the trade marks Polestar and Opalicite, by Australian China Clays under the trade mark Microbrite C80/95 and Burgess under the Trade Mark Ice white. Other calcined kaolin producers include Huber Minerals, Inner Mongolia Mengxi, Inner Mongolia Huasheng and Shanxi Jinyang Calcined Kaolin Co. Ltd. The calcined kaolin can be surface treated with an organic compound, for example a fatty acid or a fatty acid ester such as a stearate, or a basic organic compound as described in WO-A-2006/041929, or with an organosilane, organosiloxane or organosilazane to render the kaolin hydrophobic, but such treatment is not necessary for this invention (i.e. it can and preferably is used untreated in the present invention). The calcined kaolin generally has a median particle size by weight of at least 0.1 μm and less than 30 μm, preferably less than 5 μm, for example from 0.5 μm or 1 μm up to 5 μm.

In accordance with the present invention it is a requirement that the sealant compositions are free of any reinforcing filler other than calcined kaolin (e.g. free-from silica). The calcined kaolin is preferably present in a range of from 3 to 400 parts by weight per 100 parts by weight of polymer (A) of the sealant composition, more preferably at 10 to 300 parts by weight per 100 parts by weight of polymer (A). In some preferred sealant compositions according to the invention, calcined kaolin is the only filler in the composition or is the main filler, comprising for example 75 to 100% by weight of the filler in the composition. Alternatively the calcined kaolin can form 10 to 75% by weight of the filler in the composition. If kaolin is not the only filler, the composition can contain a second filler selected from those known in moisture curable sealant compositions, provided that the second filler does not react with acid released by hydrolysis of the crosslinker and does not negatively affect the physical properties of the uncured sealant composition (e.g. sag) or the subsequently cured product (e.g. elongation at break) to render them outside the scope of the present invention. Most preferably calcined kaolin is the only filler in the composition or is the main filler, comprising for example 75 to 100% by weight of the filler in the composition.

The second filler can comprise a non-reinforcing filler such as crushed quartz, diatomaceous earth, barium sulphate, iron oxide, titanium dioxide, carbon black, talc, crystobalite, mica, feldspar or wollastonite. Other fillers which might be used with calcined kaolin, optionally in addition to the above, include aluminite, calcium sulphate (anhydrite), gypsum, aluminium trihydroxide, magnesium hydroxide (brucite), graphite, aluminium oxide, or silicates from the group consisting of the olivine group, the garnet group, aluminosilicates, ring silicates, chain silicates and sheet silicates, or plastic or glass microspheres, preferably hollow microspheres. Such a non-reinforcing second filler can for example be present in an amount of from at 5 parts to 300 parts by weight per 100 parts by weight of polymer (A) in the composition with the proviso that the introduction of said second filler does not negatively affect the physical properties of the uncured sealant composition (e.g. sag) or the subsequently cured product (e.g. elongation at break) to render them outside the scope of the present invention as discussed above. Preferably when calcined kaolin is the main filler, in the composition, i.e. comprising 75 or more by weight of the filler in the composition, the second filler is present in a range of from 0.5 to 100 parts by weight, based on 100 parts of polymer (A) of the composition.

The sealant composition of the invention can include other ingredients known for use in moisture curable compositions based on silicon-bonded hydroxyl or hydrolysable groups such as sealant compositions. The composition may comprise a silicone or organic fluid which is not reactive with the polymer (A) or the crosslinking agent (B). Such a silicone or organic fluid acts as a plasticizer or extender (sometimes referred to as a processing aid) in the composition. The silicone or organic fluid can form up to 200 parts by weight per 100 parts by weight of polymer (A), preferably from 5 parts up to 150 parts by weight of per 100 parts by weight of polymer (A).

Examples of non-reactive silicone fluids useful as plasticizers include polydiorganosiloxanes such as polydimethylsiloxane having terminal triorganosiloxy groups wherein the organic substituents are, for example, methyl, vinyl or phenyl or combinations of these groups. Such polydimethylsiloxanes can for example have a viscosity of from about 5 to about 100,000 mPa·s at 25° C.

Examples of compatible organic plasticisers which can be used additionally to or instead of the silicone fluid plasticiser include dialkyl phthalates wherein the alkyl group may be linear and/or branched and contains from six to 20 carbon atoms such as dioctyl, dihexyl, dinonyl, didecyl, diallanyl and other phthalates, and analagous adipate, azelate, oleate and sebacate esters; polyols such as ethylene glycol and its derivatives; and organic phosphates such as tricresyl phosphate and/or triphenyl phosphates.

Examples of extenders for use in sealant compositions according to the invention include mineral oil based (typically petroleum based) paraffinic hydrocarbons, mixtures of paraffinic and naphthenic hydrocarbons, paraffin oils comprising cyclic paraffins and non-cyclic paraffins and hydrocarbon fluids containing naphthenics, polycyclic naphthenics and paraffins, or polyalkylbenzenes such as heavy alkylates (alkylated aromatic materials remaining after distillation of oil in a refinery). Examples of such extenders are discussed in GB2424898 the content of which is hereby enclosed by reference. Such a hydrocarbon extender can for example have an ASTM D-86 boiling point of from 235° C. to 400° C. An example of a preferred organic extender is the hydrocarbon fluid sold by Total under the trade mark G250H. The extender or plasticiser may comprise one or more non-mineral based natural oil, i.e. an oil derived from animals, seeds or nuts and not from petroleum, or a derivative thereof such as a transesterified vegetable oil, a boiled natural oil, a blown natural oil, or a stand oil (thermally polymerized oil).

Other ingredients which may be included in the sealant compositions include but are not restricted to rheology modifiers; adhesion promoters, pigments, heat stabilizers, flame retardants, UV stabilizers, chain extenders, cure modifiers, electrically and/or heat conductive fillers, and fungicides and/or biocides and the like.

The rheology modifiers include silicone organic co-polymers such as those described in EP 0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion of the sealant to substrates, particularly plastic substrates.

Examples of adhesion promoters which may be incorporated in moisture curable compositions according to the invention include alkoxysilanes such as aminoalkylalkoxysilanes, for example 3-aminopropyltriethoxysilane, epoxyalkylalkoxysilanes, for example, 3-glycidoxypropyltrimethoxysilane and, mercapto-alkylalkoxysilanes, and reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxysilanes such as 3-glycidoxypropyltrimethoxysilane with amino-substituted alkoxysilanes such as 3-aminopropyltrimethoxysilane and optionally with alkylalkoxysilanes such as methyltrimethoxysilane.

Heat stabilizers may include iron oxides and carbon blacks, iron carboxylate salts, cerium hydrate, barium zirconate, cerium and zirconium octoates, and porphyrins. Flame retardants may include hydrated aluminium hydroxide and silicates such as wollastonite.

Chain extenders may include difunctional silanes which extend the length of the polysiloxane polymer chains before cross linking occurs and, thereby, reduce the modulus of elongation of the cured elastomer. Chain extenders and crosslinkers compete in their reactions with the functional polymer ends; in order to achieve noticeable chain extension, the difunctional silane must have substantially higher reactivity than the trifunctional crosslinker with which it is used. Suitable chain extenders include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethoxydimethylsilane, diethoxydimethylsilane and α-aminoalkyldialkoxyalkylsilanes, polydialkylsiloxanes having a degree of polymerisation of from 2 to 25 and having at least two acetamido or acetoxy or amino or alkoxy or amido or ketoximo substituents per molecule, and diketoximinosilanes such as dialkylkdiketoximinosilanes and alkylalkenyldiketoximinosilanes.

Electrically conductive fillers may include carbon black, metal particles such as silver particles any suitable electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium. Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO); magnesium oxide, zinc oxide, zirconium oxide.

Fungicides and biocides include N-substituted benzimidazole carbamate, benzimidazolylcarbamate such as methyl 2-benzimidazolylcarbamate, ethyl 2-benzimidazolylcarbamate, isopropyl 2-benzimidazolylcarbamate, methyl N-{2-[1-(N,N-dimethylcarbamoyl)benzimidazolyl]}carbamate, methyl N-{2-[1-(N,N-dimethylcarbamoyl)-6-methylbenzimidazolyl]}carbamate, methyl N-{2-[1-(N,N-dimethylcarbamoyl)-5-methylbenzimidazolyl]}carbamate, methyl N-{2-[1-(N-methylcarbamoyl)benzimidazolyl]}carbamate, methyl N-{2-[1-(N-methylcarbamoyl)-6-methylbenzimidazolyl]}carbamate, methyl N-{2-[1-(N-methylcarbamoyl)-5-methylbenzimidazolyl]}carbamate, ethyl N-{2-[1-(N,N-dimethylcarbamoyl)benzimidazolyl]}carbamate, ethyl N-{2-[2-(N-methylcarbamoyl)benzimidazolyl]}carbamate, ethyl N-{2-[1-(N,N-dimethylcarbamoyl)-6-methylbenzimidazolyl]}carbamate, ethyl N-{2-[1-(N-methylcarbamoyl)-6-methylbenzimidazolyl]}carbamate, isopropyl N-{2-[1-(N,N-dimethylcarbamoyl)benzimidazolyl]}carbamate, isopropyl N-{2-[1-(N-methylcarbamoyl)benzimidazolyl]}carbamate, methyl N-{2-[1-(N-propylcarbamoyl)benzimidazolyl]}carbamate, methyl N-{2-[1-(N-butylcarbamoyl)benzimidazolyl]}carbamate, methoxyethyl N-{2-[1-(N-propylcarbamoyl)benzimidazolyl]}carbamate, methoxyethyl N-{2-[1-(N-butylcarbamoyl)benzimidazolyl]}carbamate, ethoxyethyl N-{2-[1-(N-propylcarbamoyl)benzimidazolyl]}carbamate, ethoxyethyl N-{2-[1-(N-butylcarbamoyl)benzimidazolyl]}carbamate, methyl N-{1-(N,N-dimethylcarbamoyloxy)benzimidazolyl]}carbamate, methyl N-{2-[N-methylcarbamoyloxy)benzimidazolyl]}carbamate, methyl N-{2-[1-(N-butylcarbamoyloxy)benzoimidazolyl]}carbamate, ethoxyethyl N-{2-[1-(N-propylcarbamoyl)benzimidazolyl]}carbamate, ethoxyethyl N-{2-[1-(N-butylcarbamoyloxy)benzoimidazolyl]}carbamate, methyl N-{2-[1-(N,N-dimethylcarbamoyl)-6-chlorobenzimidazolyl]}carbamate, and methyl N-{2-[1-(N,N-dimethylcarbamoyl)-6-nitrobenzimidazolyl]}carbamate. 10,10′-oxybisphenoxarsine (trade name: Vinyzene, OBPA), di-iodomethyl-para-tolylsulfone, benzothiophene-2-cyclohexylcarboxamide-S,S-dioxide, N-(fluordichloridemethylthio)phthalimide (trade names: Fluor-Folper, Preventol A3). Methyl-benzimideazol-2-ylcarbamate (trade names: Carbendazim, Preventol BCM), Zinc-bis(2-pyridylthio-1-oxide) (zinc pyrithion) 2-(4-thiazolyl)-benzimidazol, N-phenyl-iodpropargylcarbamate, N-octyl-4-isothiazolin-3-on, 4,5-dichloride-2-n-octyl-4-isothiazolin-3-on, N-butyl-1,2-benzisothiazolin-3-on and/or Triazolyl-compounds, such as tebuconazol in combination with zeolites containing silver. The fungicide and/or biocide may suitably be present in an amount of from 0 to 0.3% by weight of the composition.

The sealant compositions can be prepared by mixing the ingredients employing any suitable mixing equipment. For example, preferred one-part moisture curable compositions may be made by preparing polymer (A) in the presence of a non-reactive silicone or organic fluid extender or plasticizer, or premixing the polymer (A) with an extender or plasticizer, and mixing the resulting extended polysiloxane with all or part of the calcined kaolin, and mixing this with a pre-mix of the crosslinking agent and the catalyst. Other additives such as UV stabilisers and pigments may be added to the mixture at any desired stage. The final mixing step is carried out under substantially anhydrous conditions, and the resulting curable compositions are generally stored under substantially anhydrous conditions, for example in sealed containers, until required for use.

Such one-part moisture curable sealant compositions according to the invention are stable in storage but cure on exposure to atmospheric moisture. They are particularly suitable for sealing joints, cavities and other spaces in articles and structures which are subject to relative movement. They are thus particularly suitable as glazing sealants and for sealing building structures where the visual appearance of the sealant is important. Other suitable uses are e.g. sealing joints in appliances e.g. fridges, ovens etc., furniture, sanitary ware, automobiles and trains.

The sealant composition of the invention can alternatively be a two-part composition in which the polymer (A) and the crosslinking agent (B) are packaged separately. In such a composition the kaolin and the catalyst are preferably packaged with the polymer (A). Both packages in such a two-part composition can be anhydrous for curing on exposure to atmospheric moisture, or one only of the packages may contain a controlled amount of moisture to speed up initial cure of the composition on mixing of the packages. Such 2 part systems are mixed immediately prior to use. Typically they are mixed in ratios (Polymer A mix to cross-linker mix) of 1:10 to 10:1.

Compositions in accordance with the present invention are non-sagging prior to cure as they have a value of less than 5 mm flow after 15 minutes as measured by ASTM D2202. Preferably, the composition in accordance with the present invention have a value of less than 3 mm flow as measured by ASTM D2202.

Compositions in accordance with the present invention, subsequent to curing have an elongation at break value of at least 250% according to ASTM D412-98 a for 2 mm sheets. Preferably elongation at break is greater than 350% according to ASTM D412-98 a for 2 mm sheets.

Preferably upon curing the resulting products of compositions in accordance with the present invention additionally have a tear strength of greater than 6 kN/m as measured by ASTM D 624 using Die B.

The invention is illustrated by the following Examples, in which parts and percentages are by weight. All viscosities of starting materials are given as pre-measured values provided by suppliers and viscosity measurements taken during experiments were measured using a Brookfield® HB DV-II+PRO with a cone plate spindle at a speed of 5 rpm. All viscosity measurements were taken at 25° C. unless otherwise indicated.

In Examples 1 to 7 and Comparative Examples C1 to C11, the Polymer used was a dihydroxy terminated polydimethylsiloxane with a viscosity of 80000 mPas. The Crosslinker was a mixture of approximately equal amounts of methyltriacetoxysilane and ethyltriacetoxysilane. The Organic extender was a mineral oil product sold by Total under the trade mark G250H. The Silicone oil was a trimethylsilyl-terminated polydimethylsiloxane of viscosity 100 mPas. The Catalyst was dibutyltin diacetate.

### EXAMPLES 1 TO 3 AND COMPARATIVE EXAMPLE C1a

The moisture curable sealant compositions of Examples 1 to 3 and comparative example C1a were prepared by mixing the ingredients listed in a 5 l Neulinger mixer and filling the mixed composition into cartridges. The compositions were tested after 7 days storage in the cartridge at ambient temperature, and where indicated after accelerated ageing in the cartridge at 50° C. for 28 days.

Penetration was measured according to ASTM D127-97, values are given in mm/10 for a measurement of 3 seconds. The stringing of the sealant is determined by measuring the maximum length of a string which can be pulled from the surface of a sample using a plastic nozzle and a tensiometer pulling with a speed of 1000 mm/min. Extrusion is the rate of extrusion in g/min. measured using a calibrated metal nozzle with a inner diameter of 5 mm of and a length of 90 mm and applying a pressure of 0.8 bar (0.8×10⁵ Pa) to the cartridge. Skin over time SOT in seconds was measured by a finger test. The time required for the sealant not to leave any sealant traces on the finger, after gently touching the sealant surface, was recorded as SOT in minutes. Flow in mm. (i.e. sag) was measured by means of a flow jig after 15 minutes according to ASTM D 2202.

The tensile tests were performed in accordance with ASTM D412-98a using a 2 mm specimen sheet. ‘Tensile’ means tensile strength (breaking stress) in MPa. ‘Modulus 100%’ is the nominal stress (or apparent stress, in MPa) at 100% elongation.

Elongation (at break) is given in % according to ASTM D412-98 a for 2 mm sheets. The Hardness was Shore A hardness measured according to ASTM D2240-02b.

The tear strength in kN/m was measured by ASTM D 624 using Die B.

The formulation of the compositions of Examples 1 to 3 and comparative example C1a is shown in Table 1. Calcined Kaolin A has median particle size 1.5 μm (Malvern), surface area BET 16 g/m² and oil absorption 80 ml/100 g (ISO 787).

The talc, designated Talc A in table 1, was sold by IMI under the trade name HTP3. The results of testing these compositions are also shown in Table 1. Table 1 also shows the results of testing a typical commercially available silica filled sealant using an acetoxy crosslinker as Comparison 1.

TABLE 1

| | | | | Com- | Com- |
|---|---|---|---|---|---|
| | | | | parison | parison |
| Formulation | Example 1 | Example 2 | Example 3 | C1a | C1b |
| Polymer | 40.48% | 40.48% | 30.48% | 30.48% | ~60% |
| Organic | 15% | — | 25% | 15% | ~27% |
| extender | | | | | |
| Silicone oil | 0 | 15% | — | — | — |
| Crosslinker | 4.5% | 4.5% | 4.5% | 4.5% | ~4.5% |
| Catalyst | 0.02% | 0.02% | 0.02% | 0.02% | ~0.02% |
| Calcined | 40% | 40% | 40% | 25% | — |
| Kaolin A | | | | | |
| Talc A | — | — | — | 25% | |
| Fumed silica | — | — | — | — | ~8% |

Properties 1 week RT

| | | | | | |
|---|---|---|---|---|---|
| Penetration | 137 | 93 | 156 | 59 | 285 |
| Stringing | 29 | 36 | 15 | 22 | 21 |
| Extrusion | 182 | 92 | 408 | 69 | 541 |
| SOT | 9 | 8 | 13 | 3 | 16 |
| Flow (Sag) | 0.5 | 0 | 0.5 | 0 | 1 |
| Tensile | 3.90 | 4.37 | 3.04 | 2.71 | 1.31 |
| Elongation at | 373 | 384 | 518 | 197 | 482 |
| break | | | | | |
| Modulus | 1.09 | 1.15 | 0.67 | 1.92 | 0.33 |
| 100% | | | | | |
| Hardness | 41 | 32 | 31 | 51 | 15 |
| Tear Die B | 9.21 | 10.26 | 8.98 | 8.38 | 3.61 |

Properties after ageing for 28 days at 50° C.

| | | | | | |
|---|---|---|---|---|---|
| Penetration | 129 | 90 | 140 | 58 | 233 |
| Stringing | 16 | 22 | 11 | 37 | 25 |
| Extrusion | 196 | 103 | 424 | 88 | 562 |
| SOT | 10 | 8 | 22 | 3 | 17 |
| Flow (Sag) | 0.5 | 0.5 | 0.5 | 0.5 | 1 |
| Tensile | 3.28 | 3.57 | 2.6 | 2.43 | 1.26 |
| Elongation at | 343 | 383 | 336 | 175 | 527 |
| break | | | | | |
| Modulus | 1.00 | 0.99 | 0.64 | 1.85 | 0.33 |
| 100% | | | | | |
| Hardness | 43 | 45 | 27 | 48 | 18 |
| Tear Die B | 8.56 | 8.88 | 8.36 | 7.96 | 3.89 |

Examples 1 to 3 show that acetoxy-crosslinked sealants filled with calcined kaolin have surprisingly good mechanical properties, with tear strength and hardness even superior to typical silica filled sealants. They also have a flow measurement which indicates they are non-sagging and an elongation at break of >350%.

The sealants filled with calcined kaolin also have good shelf stability in the accelerated ageing test. Comparative example C1a shows that mixing calcined kaolin with a filler such as talc on a 1:1 basis results in a composition that provides acceptable Flow (sag) results, i.e. the composition is non-sagging before cure, but the introduction of such a large proportion of talc lends itself to an unacceptable elongation at break to render it outside the scope of the present invention. Comparative example C1 b uses a silica filler and it is notable that the kaolin filled examples give comparative, if not better results than the silica filled composition.

### COMPARATIVE EXAMPLES C2 AND C3

Sealant compositions were prepared using kaolin sold by Huber Minerals under the trade mark 90, designated as Kaolin A in Table 2. This is an uncalcined kaolin stated to have a low moisture content. The formulations were prepared using a Hausschild dental mixer and filled in cartridges. The formulation of the compositions is shown in Table 2.

TABLE 2

| | Comparative | Comparative |
|---|---|---|
| Formulation | Example C2 | Example C3 |
| Polymer | 30.48% | 20.48% |
| Organic extender | 25% | 25% |
| Silicone oil | 0 | 0 |
| Crosslinker | 4.5% | 4.5% |
| Catalyst | 0.02% | 0.02% |
| Kaolin A | 40% | 50% |

The sealants of Comparative Examples C2 and C3 could not be subjected to the test procedures because the sealants had completely cured in the cartridge within 24 hours. These Comparative Examples show that uncalcined kaolin, even of low moisture content, does not provide a shelf stable acetoxy-crosslinked sealant.

### COMPARATIVE EXAMPLES C4 AND C5

Sealant compositions were prepared in the 5 l Neulinger mixer using metakaolin sold by Imerys under the trade mark Metastar®, which is stated to have a low moisture content. The formulation of the compositions and the test results obtained are shown in Table 3

TABLE 3

| | Comparative | Comparative |
|---|---|---|
| Formulation | Example C4 | Example C5 |
| Polymer | 35.48% | 30.48% |
| Organic extender | 10% | 15% |
| Crosslinker | 4.5% | 4.5% |
| Catalyst | 0.02% | 0.02% |
| Metakaolin | 50% | 50% |

Properties 1 week RT

| | | |
|---|---|---|
| Penetration | 178 | 191 |
| Stringing | 241 | 140 |
| Extrusion | 58 | 118 |
| SOT | 8 | 8 |
| Flow (Sag) | 30 | 8 |
| Tensile (sheet 2 mm) | 3.84 | 2.78 |
| Elongation at break | 154 | 142 |
| Modulus 100% | 2.58 | 1.97 |
| Hardness | 34 | 34 |
| Tear Die B | 7.4 | 7.0 |

Properties 28 days° 50 C.
Sealants completely cured in cartridge, not measurable

Comparative Examples C4 and C5 show that the sealants filled with Metakaolin were not shelf stable in the accelerated ageing test.

### COMPARATIVE EXAMPLES C6 AND C7

Sealant compositions were prepared using talc or wollastonite as filler in a 5 l Neulinger mixer. The talc, designated Talc A in Table 4, was sold by IMI under the trade name HTP3. The wollastonite was supplied by Nyad under the trade name N400. The formulation of the compositions and the test results obtained are shown in Table 4.

TABLE 4

| | Comparative | Comparative |
|---|---|---|
| Formulation | Example C6 | Example C7 |
| Polymer | 30.48% | 35.48% |
| Organic extender | 15% | 15% |
| Crosslinker | 4.5% | 4.5% |
| Catalyst | 0.02% | 0.02% |
| Talc A | 50% | — |
| Wollastonite | — | 45% |

Properties after 1 week at RT

| | | |
|---|---|---|
| Penetration | 132 | 1857 |
| Stringing | 27 | 50 |
| Extrusion | 278 | 1061 |
| SOT | 4 | 17 |
| Flow | 0.5 | 54 |
| Tensile (sheet 2 mm) | 1.80 | 1.21 |
| Elongation at break | 131 | 188 |
| Modulus 100% | 1.54 | 0.74 |
| Hardness | 35 | 28 |
| Tear Die B | 5.3 | 4.5 |

Properties after ageing for 28 days at 50° C.

| | | |
|---|---|---|
| Penetration | 110 | 1840 |
| Stringing | 28 | 74 |
| Extrusion | 221 | 1066 |
| SOT | 10 | 18 |
| Flow (Sag) | 1 | >100 |
| Tensile (sheet 2 mm) | 1.13 | 1.09 |
| Elongation at break | 64 | 187 |
| Modulus 100% | 1.69 | 0.68 |
| Hardness | 28 | 25 |
| Tear Die B | 6.5 | 3.68 |

Comparative Examples C6 and C7 show that while talc and wollastonite allow the formulation of shelf stable acetoxy-crosslinked sealants, the mechanical properties of the sealants produced are poor especially for the talc. It is also to be noted that the flow values for the wollastonite filled composition increased significantly after aging. Hence neither formulations shown provide a suitable commercially viable sealant composition.

### EXAMPLES 4 TO 6

The compositions of Examples 4 to 6 were prepared by mixing the ingredients listed in a Hausschild laboratory mixer (dental mixer) and filling the mixed composition into cartridges. The compositions were tested after 24 hours storage in the cartridge at ambient temperature.

Examples 4 and 5 used different grades of calcined kaolin as filler in an acetoxy-crosslinked sealant. Calcined kaolin A is as hereinbefore described. Calcined kaolin B has a median particle size of 3.2 μm (Malvern), a surface area of 8 g/m², a specific gravity of 2.63 and an oil absorption of 54 ml/100 g (ISO787). Calcined kaolin C has a median particle size of from 1.2 to 2.1 μm (Malvern), a surface area of 8.5 g/m² and a specific gravity of 2.6. Example 6 used calcined Kaolin A at a lower level than used in Example 1. The formulations and results of these Examples are shown in Table 5.

TABLE 5

| Formulation | Example 4 | Example 5 | Example 6 |
|---|---|---|---|
| Polymer | 30.48% | 30.48% | 40.48% |
| Organic extender | 25% | 25% | 25% |
| Crosslinker | 4.5% | 4.5% | 4.5% |
| Catalyst | 0.02% | 0.02% | 0.02% |
| Filler | 40% calcined | 40% calcined | 30% calcined |
| | Kaolin C | Kaolin B | Kaolin A |
| Properties | | | |
| (24 hours) | | | |
| Flow (mm) (Sag) | 3 | 1 | 3 |
| Hardness (Shore A) | 22 | 21 | 20 |
| Tensile (Mpa) | 1.75 | 2.45 | 2.13 |
| Elongation at break | 364 | 374 | 380 |
| (%) | | | |
| 100% Modulus | 0.46 | 0.65 | 0.49 |
| (Mpa) | | | |

Examples 4 to 6 show that acetoxy-crosslinked sealants filled with different grades of calcined kaolin show similar good mechanical properties.

### COMPARATIVE EXAMPLES C8 TO C11

Comparative Examples C8 to C11 used various fillers as an alternative to calcined kaolin in acetoxy-filled sealants. Talc B was sold by IMI under the trade name HTP4. The crystabolite was sold by Sibelco under the trade name M3000. The formulation of these Comparative Examples is shown in Table 6.

The compositions of Comparative Examples C8 to C11 were prepared and tested in exactly the same way as for Examples 5 to 7. The results are shown in Tables 6.

TABLE 6

| | Comparative | Comparative | Comparative | Comparative |
|---|---|---|---|---|
| Formulation | Example C8 | Example C9 | Example C10 | Example C11 |
| Polymer | 30.48% | 30.48% | 30.48% | 30.48% |
| Organic extender | 25% | 25% | 25% | 25% |
| Crosslinker | 4.5% | 4.5% | 4.5% | 4.5% |
| Catalyst | 0.02% | 0.02% | 0.02% | 0.02% |
| Filler | 40% mica | 40% Talc B | 40% feldspar | 40% Cristobalite |
| Properties (24 hours) | | | | |
| Flow (mm) (Sag) | 2.5 | >100 | >100 | >100 |
| Hardness (Shore A) | 21 | 17 | 10 | 8 |
| Tensile (Mpa) | 1.00 | 0.78 | 0.53 | 0.73 |
| Elongation at break (%) | 88 | 158 | 233 | 233 |
| 100% Modulus (Mpa) | 0.77 | 0.54 | 0.28 | 0.34 |

Comparative Examples C8 to C11 show that other materials known as non-reinforcing fillers in sealants form acetoxy-crosslinked sealants having poor mechanical properties and/or excessive flow (sag) of uncured sealant.

1. A moisture curable sealant composition comprising an organopolysiloxane (A) containing reactive hydroxyl or hydrolysable groups bonded to silicon, a crosslinking agent (B) containing hydrolysable groups reactive with the reactive groups of (A) in the presence of moisture, the hydrolysable groups of (B) releasing an acid in the presence of moisture, a metal-containing catalyst for the reaction of the reactive groups of (A) with the hydrolysable groups of (B), and a filler, characterized in that the filler comprises calcined kaolin and is free of any other reinforcing filler and methanol.

2. A composition according to claim 1, characterized in that the kaolin has a median particle size by weight of 0.1 to 30 μm.

3. A composition according to claim 2, characterized in that the kaolin has a median particle size by weight of 1 to 5 μm.

4. A composition according to claim 1, characterized in that the kaolin is present in a range of from 3 to 400 parts by weight per 100 parts by weight of polymer (A).

5. A composition according to claim 4, characterized in that the kaolin is present in a range of from 10 to 300 parts by weight per 100 parts by weight of polymer (A).

6. A composition according to claim 1, characterized in that the kaolin forms 75 to 100% by weight of the filler in the composition.

7. A composition according to claim 6, characterized in that a non-reinforcing second filler is present in a range of from 0.5 to 100 parts by weight, based on 100 parts of polymer (A) of the composition.

8. A composition according to claim 7, characterized in that the second filler is a silicate filler other than kaolin.

9. A composition according to claim 8, characterized in that the second filler is selected from wollastonite, talc, quartz and cristobalite.

10. A composition according to any of claim 1, characterized in that the organopolysiloxane is a hydroxy-terminated polydiorganosiloxane.

11. A composition according to any of claim 1, characterized in that the crosslinking agent is one or more acetoxysilane(s).

12. A composition according to claim 1, characterized in that the composition further comprises a silicone or organic fluid which is not reactive with the polymer (A) or the crosslinking agent (B).

13. A composition according to any of claim 1, characterized in that upon curing the resulting product has a tear strength of greater than 6 kN/m.

14-15. (canceled)

16. A composition in accordance with any claim 1 characterised in that prior to use the composition is packaged in two parts with the polymer (A) and the crosslinking agent (B) packaged separately.

17. A composition according to claim 1, characterized in that the composition upon curing has an elongation at break of more than 250%.

18. A composition according to claim 1, characterized in that the composition is non sagging.

19. A composition according to claim 1, wherein the non sagging composition has a value, as measured according to ASTM D2202, of less than 5 mm flow after 15 minutes.

20. A composition according to claim 19, characterized in that the kaolin is present in a range of from 3 to 400 parts by weight per 100 parts by weight of polymer (A).

21. A composition according to claim 20, characterized in that the kaolin forms 75 to 100% by weight of the filler in the composition.
